(19) United States
(12) Patent Application Publication
(10) Pub. No.: US 2009/0245402 A1
(43) Pub. Date: Oct. 1, 2009

(54) APPARATUS AND METHOD FOR TILE PROCESSING IN WIRELESS COMMUNICATIONS

(75) Inventors: Niranjan N. Ratnakar, Hillsborough, NJ (US); Jingyuan Liu, Morris Plains, NJ (US); Joshua Lawrence Koslov, Hopewell, NJ (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/413,514

(22) Filed: Mar. 27, 2009

Related U.S. Application Data
(60) Provisional application No. 61/041,235, filed on Mar. 31, 2008.

(51) Int. Cl. H04L 27/28

(52) U.S. Cl. 375/260

(57) ABSTRACT

An apparatus and method for tile processing using a plurality of tile descriptors comprising defining the plurality of tile descriptors in a time-frequency plane; preparing the plurality of tile descriptors to be sent to a receiver for storage; allocating at least one tile associated with the plurality of tile descriptors to a user; and notifying the allocated at least one tile to a transmitter for transmitting a wireless signal to the user using the allocated at least one tile. In one aspect, the apparatus and method further comprise receiving the wireless signal, wherein the wireless signal comprises an encoded user message; retrieving the plurality of tile descriptors from a memory unit; and demodulating the wireless signal using the plurality of tile descriptors to obtain the encoded user message.

### CLAIM OF PRIORITY UNDER 35 U.S.C. §119

The present Application for Patent claims priority to Provisional Application No. 61/041,235 entitled “Tile Processing in Wireless Communications” filed Mar. 31, 2008, and assigned to the assignee hereof and hereby expressly incorporated by reference herein.

### FIELD

This disclosure relates generally to apparatus and methods for tile processing. More particularly, the disclosure relates to tile processing using pre-defined tile descriptors in wireless communications.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP LTE systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-input-single-output (SISO), multiple-input-single-output (MISO) or a multiple-input-multiple-output (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min {N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system supports time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point. An access point (AP) is also known as a base station and is the part of the wireless system that allows user access to an access terminal (AT) or mobile station (MS).

### SUMMARY

Disclosed is an apparatus and method for tile processing using pre-defined tile descriptors. According to one aspect, a method for tile processing using a plurality of tile descriptors comprising defining the plurality of tile descriptors in a time-frequency plane; preparing the plurality of tile descriptors to be sent to a receiver for storage; allocating at least one tile associated with the plurality of tile descriptors to a user; and notifying the allocated at least one tile to a transmitter for transmitting a wireless signal to the user using the allocated at least one tile.

According to another aspect, a method for tile processing using a plurality of tile descriptors comprising receiving a wireless signal, wherein the wireless signal comprises an encoded user message; retrieving the plurality of tile descriptors from a memory unit; and demodulating the wireless signal using the plurality of tile descriptors to obtain the encoded user message.

According to another aspect, a central entity for tile processing using a plurality of tile descriptors comprising an input/output interface for receiving and transmitting a wireless signal; and a processor coupled with a memory storing software codes, wherein the software codes are instructions implemented by the processor to a) define the plurality of tile descriptors in a time-frequency plane, b) prepare the plurality of tile descriptors to be sent to a receiver for storage, c) allocate at least one tile associated with the plurality of tile descriptors to a user, and d) notify the allocated at least one tile to a transmitter for transmitting the wireless signal to the user using the allocated at least one tile.

According to another aspect, a receiver for tile processing using a plurality of tile descriptors comprising an antenna for receiving a wireless signal wherein the wireless signal comprises an encoded user message, and for receiving the plurality of tile descriptors; a memory unit for storing the plurality of tile descriptors; and a processor for retrieving the plurality of tile descriptors from the memory unit and for demodulating the wireless signal using the plurality of tile descriptors to obtain the encoded user message.

According to another aspect, an apparatus for tile processing using a plurality of tile descriptors comprising means for defining the plurality of tile descriptors in a time-frequency plane; means for preparing the plurality of tile descriptors to be sent to a receiver for storage; means for allocating at least one tile associated with the plurality of tile descriptors to a user; and means for notifying the allocated at least one tile to a transmitter for transmitting a wireless signal to the user using the allocated at least one tile.

According to another aspect, an apparatus for tile processing using a plurality of tile descriptors comprising means for receiving a wireless signal, wherein the wireless signal comprises an encoded user message; means for retrieving the plurality of tile descriptors from a memory unit; and means for demodulating the wireless signal using the plurality of tile descriptors to obtain the encoded user message.

According to another aspect, a computer-readable medium having a computer program comprising instructions, which when executed by at least one processor, operates to process tiles using a plurality of tile descriptors, the computer program comprising instructions for defining the plurality of tile descriptors in a time-frequency plane; instructions for preparing the plurality of tile descriptors to be sent to a receiver for storage; instructions for allocating at least one tile associated with the plurality of tile descriptors to a user; and instructions for notifying the allocated at least one tile to a transmitter for transmitting a wireless signal to the user using the allocated at least one tile.

According to another aspect, a computer-readable medium having a computer program comprising instructions, which when executed by at least one processor, operates to process tiles using a plurality of tile descriptors, the computer program comprising instructions for receiving a wireless signal, wherein the wireless signal comprises an encoded user message; instructions for retrieving the plurality of tile descriptors from a memory unit; and instructions for demodulating the wireless signal using the plurality of tile descriptors to obtain the encoded user message.

Advantages of the present disclosure include an efficient way of describing tiles which may be pre-stored and referenced as needed using a job descriptor which points to that tile descriptor.

It is understood that other aspects will become readily apparent to those skilled in the art from the following detailed description, wherein it is shown and described various aspects by way of illustration. The drawings and detailed description are to be regarded as illustrative in nature and not as restrictive.

### BRIEF DESCRIPTION OF THE DRAWINGS

FIG. 1 illustrates an example of a multiple access wireless communication system.

FIG. 2 illustrates an example block diagram of a transmitter system (a.k.a. access point) and a receiver system (a.k.a. access terminal) in a MIMO system.

FIG. 3 illustrates examples of tiles in the time-frequency plane.

FIG. 4 illustrates an example of UMB Pilot Positions within a tile.

FIG. 5 illustrates an example of pilot or pilot cluster positions in the time-frequency plane showing four pilots, P0, P1, P2 and P3.

FIG. 6 illustrates an example flow for tile processing using pre-defined tile descriptors.

### DETAILED DESCRIPTION

The detailed description set forth below in connection with the appended drawings is intended as a description of various aspects of the present disclosure and is not intended to represent the only aspects in which the present disclosure may be practiced. Each aspect described in this disclosure is provided merely as an example or illustration of the present disclosure, and should not necessarily be construed as preferred or advantageous over other aspects. The detailed description includes specific details for the purpose of providing a thorough understanding of the present disclosure. However, it will be apparent to those skilled in the art that the present disclosure may be practiced without these specific details. In some instances, well-known structures and devices are shown in block diagram form in order to avoid obscuring the concepts of the present disclosure. Acronyms and other descriptive terminology may be used merely for convenience and clarity and are not intended to limit the scope of the present disclosure.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

The techniques described herein may be used for various wireless communication networks such as, but not limited to, Orthogonal FDMA (OFDMA) networks, WiMax, etc. The terms “networks” and “systems” are often used interchangeably. An OFDMA network may implement a radio technology such as Evolved UTRA (E-UTRA), IEEE 802.11, IEEE 802.16, IEEE 802.20, Flash-OFDM®, Long Term Evolution (LTE), etc. These various radio technologies and standards are known in the art. For clarity, certain aspects of the techniques are described below, for example, for LTE, and LTE terminology is used in much of the description below. However, one skilled in the art would understand that the example description should not be construed as limiting the present disclosure.

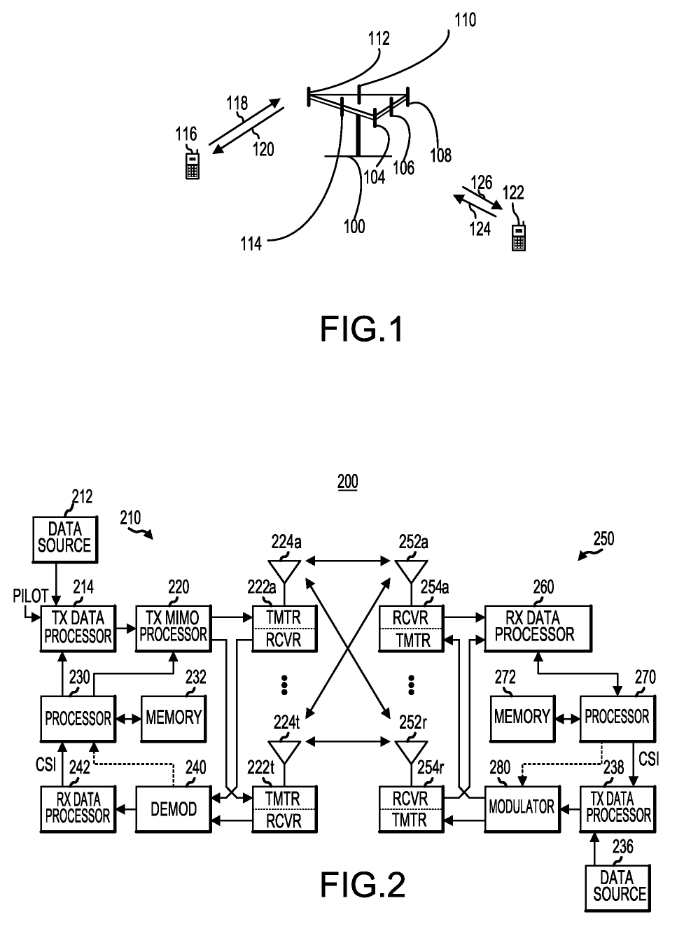

FIG. 1 illustrates an example of a multiple access wireless communication system. As illustrated in FIG. 1, an access point 100 (AP) includes multiple antenna groups, one group including 104 and 106, another group including 108 and 110, and an additional group including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. For example in a frequency division duplex (FDD) system, communication links 118, 120, 124 and 126 use different frequencies in the forward links 120 and 126 than those used by reverse links 118 and 124.

Each group of antennas and/or the area in which they are designed to communicate is often referred to as a sector of the access point. In one aspect, each antenna group is designed to communicate to access terminals in a particular sector of the areas covered by access point 100.

In communication over forward links 120 and 126, the transmitting antennas of access point 100 utilize beamforming in order to improve the signal-to-noise ratio (SNR) of forward links for the different access terminals 116 and 122. Also, an access point using beamforming to transmit to access terminals scattered randomly through its coverage causes less interference to access terminals in neighboring cells than an access point transmitting through a single antenna to all its access terminals.

One skilled in the art would understand that although the term access point is used, other equivalent terminology may be used in its place without affecting the spirit or scope of the present disclosure. For example, an access point may be a fixed station used for communicating with the access terminals and may be referred to as a base station, a fixed station, a node or some other similar terminology. Similarly, the term access terminal can equally refer to a mobile terminal, a handheld, user equipment (UE), a wireless communication device, terminal or another similar term without affecting the spirit or scope of the present disclosure.

FIG. 2 illustrates an example block diagram of a transmitter system 210 (a.k.a. access point) and a receiver system 250 (a.k.a. access terminal) in a MIMO system 200. At the transmitter system 210, traffic data for a number of data streams is provided from a data source 212 to a transmit (TX) data processor 214. In one aspect, each data stream is transmitted over a respective transmit antenna. TX data processor 214 formats, codes, and interleaves the traffic data for each data stream based on a particular coding scheme selected for that data stream to provide coded data.

In one aspect, the coded data for each data stream is multiplexed with pilot data using orthogonal frequency division multiplex (OFDM) techniques. The pilot data is typically a known data pattern that is processed in a known manner and is used at the receiver system to estimate the channel response. The coded data for each data stream is then modulated (i.e., symbol mapped) based on a particular modulation scheme (e.g., BPSK, QSPK, M-PSK, or M-QAM) selected for that data stream to provide modulation symbols. Pilot modulation symbols are inserted for use by the receiver in channel estimation. The data rate, coding, and modulation for each data stream are determined by instructions performed by processor 230.

The modulation symbols for all data streams are then provided to a TX MIMO processor 220, which further process the modulation symbols (e.g., for OFDM). TX MIMO processor 220 then provides N_{T} modulation symbol streams to N_{T} transmitters (TMTR) 222a through 222t. In an example, the TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210. A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reverse link message transmitted by the receiver system 250. Processor 230 then determines which pre-coding matrix to use for determining the beamforming weights then processes the extracted message.

In one example, orthogonal frequency division multiple access (OFDMA) is used as a multiple access technique in the wireless system. In this scheme, communication resources are divided into discrete units of time and of frequency. For example, time may be divided up into discrete units of size Δt and frequency may be divided up into discrete units of size Δf. In general, a communication resource allocation for OFDMA may consist of a contiguous region of the time-frequency plane known as a tile. A tile may consist of, for example, M time units and N frequency units. In this case, the tile has dimensions of MΔt×NΔf.

In a communications system, for example, using OFDMA, communication resources allocated to various users may be divided into isolated tiles. In a receiver, each tile may have associated structural information to permit the receiver to extract, for example, known pilot symbols for channel estimation and subsequent demodulation. Tiles may have different shapes or pilot positions, requiring different receive processing. The receiver is provided tile descriptions to enable proper receive processing.

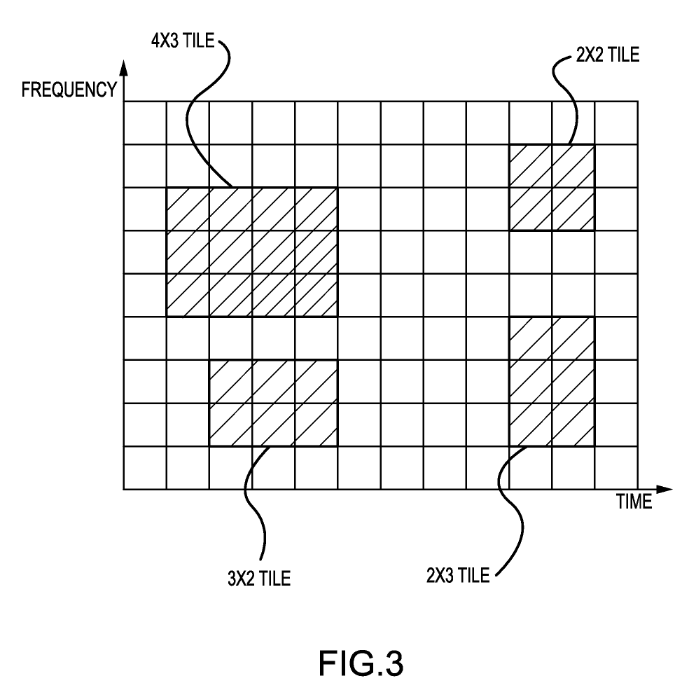

A resource allocation over the time-frequency plane is known as a tile. In one example, a tile has dimensions of MΔt×NΔf, where the time unit is Δt and frequency unit is Δf. In one example, the time unit is known as a symbol and the frequency unit is known as a subcarrier. FIG. 3 illustrates examples of tiles in the time-frequency plane. In general, a tile occupies a discrete region in the time-frequency plane and does not overlap with other tiles. Moreover, in one example, tile allocations may vary as a function of time. Special reference signals known as pilots may be assigned to each tile, for example, and may be located within a specific time and frequency unit.

Tiles may have different shapes or pilot positions, requiring different receive processing. However, a reasonable number of tile descriptions may be pre-stored, describing all expected tile formats, and then referenced when needed, for a particular tile, via a job descriptor pointing to that description. Further, receiver processing may be performed on different scales: for example, an “assignment” for a given link, e.g. mobile to base station, may comprise multiple tiles. Once information related to an assignment is supplied to receiver hardware, certain information may be replicated for these multiple tiles in the form of tile job descriptors.

Further, the tiles may be correlated in their locations in frequency or time. For example, in the Ultra Mobile Broadband (UMB) system, time is broken into frames, comprising eight OFDM symbols: within these frames, multiple tiles encompassing regions of eight modulation symbols in time by 16 subcarriers in frequency, are sent at a transmitter. It is efficient to aggregate the receiver processing for such a frame into a job table, containing common parameters that may be needed throughout the frame, as well as pointers to job descriptors which apply to individual tiles within that frame.

In one example, a receiver needs to extract information from received tiles. Demodulation and other operations need to be performed prior to error-correction decoding; for example, pilot extraction, channel estimation, maximal ratio combining (MRC) or MIMO (multiple-input multiple-output) estimation, bit slicing or soft values/LLR (log-likelihood ratio) generation.

In one aspect, parameters (tile descriptors) needed to process a given tile may include one or more of the following:

Shape of tile (N subcarriers by M OFDM symbols);

Pilot or pilot cluster positions;

Pilot descrambling values;

Pilot cluster despreading functions;

Modulation order;

Number of orthogonal layers (for MIMO or multi-access processing). One skilled in the art would understanding that these parameters mentioned herein are examples and not exclusive. Thus, some of the mentioned parameters may be deleted while other parameters may be included without affecting the spirit or scope of the present disclosure.

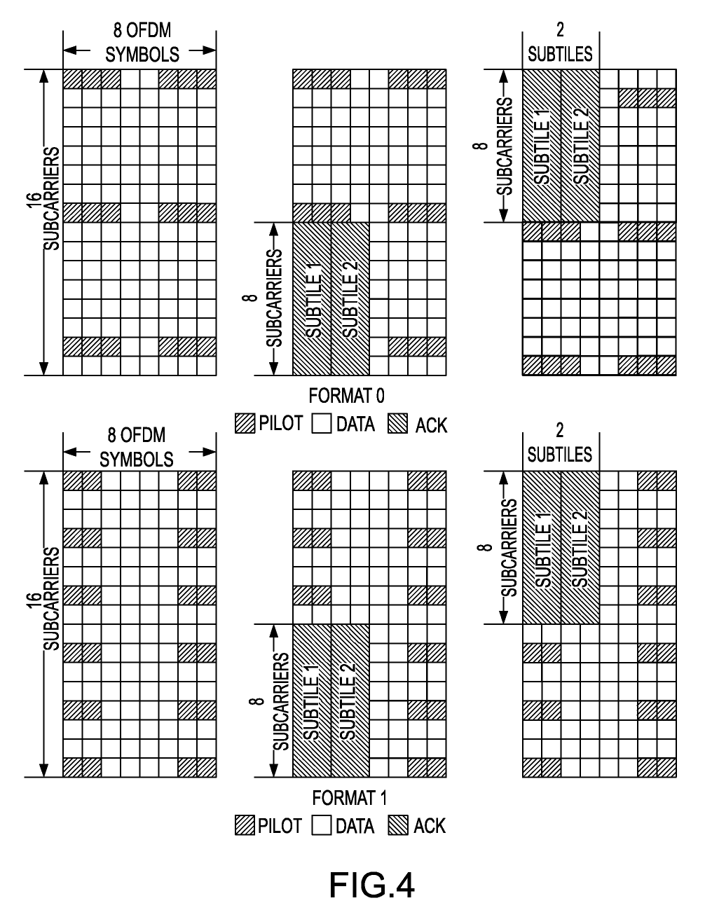

As an example, a Ultra Mobile Broadband (UMB) system is considered. With regard to the parameters shape of tile and pilot or cluster positions, in the uplink (i.e., reverse link), pilots within a tile may be arranged as shown in FIG. 4. FIG. 4 illustrates an example of UMB Pilot Positions within a tile. As illustrated in FIG. 4, the complete description of the tile shape and pilot positions is given by passing the index 0 or 1 for Pilot Format 0 or 1, respectively.

The UMB standard states with regard to pilot descrambling values that the scrambling symbols for a tile depend on the tile index T which shall be equal to (fMIN−NGUARD, LEFT)/NBLOCK, where fMIN is the lowest indexed subcarrier in that tile. For the tile with index T within any Physical Frame in the superframe with index SFInd, a complex scrambling sequence is generated using a common complex scrambling algorithm. The kth symbol c(k) in the complex scrambling sequence is used to scramble the Reverse Dedicated Pilot Channel subcarrier with the Reverse Dedicated Pilot Channel index k. The scrambling operation consists of multiplying the unscrambled complex symbol on the subcarrier with the scrambling symbol c(k).

That is, the descrambling values are a function of the tile index T within the frame, and a SectorSeed which is common over all the tiles. Therefore, passing the SectorSeed, for example, once per frame, but including the tile index T as a tile descriptor, would allow regeneration of the pilot descrambling sequence.

The UMB standard states the following with regard to pilot cluster despreading functions.

### For Pilot Format 0:

The complex value of all Reverse Dedicated Pilot Channel modulation symbols in OFDM symbol indexed t shall be given by:

$${S}_{t} = \sqrt{{P}_{ODCH}} exp ( \frac{j2π}{3} ( CodeOffset ) ( t mod 8 ) ) if t mod 8 < 4 , and$$

$${S}_{t} = \sqrt{{P}_{ODCH}} exp ( \frac{j2π}{3} ( CodeOffset ) ( 7 - ( t mod 8 ) ) ) if t mod 8 \geq 4.$$

where j denotes the complex number (0, 1), and PODCH denotes the energy per modulation symbol of by the Reverse OFDMA Data Channel in the tile.

### For Pilot Format 1:

The complex value of all Reverse Dedicated Pilot Channel modulation symbols in OFDM symbol indexed t shall be given by:

Sₜ=\sqrt{P_{ODCH}} exp(jπ(CodeOffset)(t mod 8)) if t mod 8<4, and

Sₜ=\sqrt{P_{ODCH}} exp(jπ(CodeOffset)(7−(t mod 8))) if t mod 8>4.

That is, the despreading values Sₜ is a function of the symbol number t within the frame, and the CodeOffset number. Therefore, the tile descriptor can be passed the CodeOffset. The despreading functions can be regenerated. For the case of MIMO or multi-access (e.g., QORL quasi-orthogonal reverse link) processing, a table of the multiple CodeOffsets used for that link is passed.

In one example, a CodeOffsets table directly provides information on a number of orthogonal layers (for MIMO or multi-access processing) as the number of ones present.

For example, in the UMB system, a vector of three bits formatted as b2b1b0 may be passed, where any 1 indicates that that code offset is to be processed. For example, b2b1b0=101 would indicate a) that MIMO or multi-access is being sent, b) to process layers (CodeOffsets) 0 and 2, and c) to perform required MIMO or multi-access estimation of the symbols for each layer. For example, b2b1b0=100 would indicate that a) CodeOffset 2 is being sent, b) to perform Maximum Ratio Combining (MRC) estimation (in the case of multiple receive antennas), and c) to estimate the received symbols for the single layer.

For example, with regard to modulation order, in UMB, a number of different constellations are employed, related to the packet format, which includes also hybrid automatic repeat request (H-ARQ) parameters and decoding parameters. In order to generate LLR values for the tile, a descriptor is sent to the soft-decoding unit (“slicer”) indicating whether the modulation symbols extracted after MRC or MIMO processing are to be interpreted as QPSK, 8-PSK, 16-QAM or 64-QAM. Hence, a single number 0 through 3 is sent to enumerate the constellation type.

In other examples, in a communications receiver, isolated regions in time and frequency are processed to determine an estimate of the channel conditions. Other parameters needing to be estimated, e.g. time and frequency offsets and variability in time and frequency, are normally estimated when complete, not isolated, information about the channel in time and frequency is available.

In the UMB receiver, tiles, or regions of contiguous OFDM subcarriers in frequency and OFDM symbols in time, contain pilot symbols which are used to estimate channel conditions for all of the modulation symbols within that tile. Additional parameters from each of these tile estimates are derived, e.g., estimates of the change in channel phase over time and change in channel phase over frequency; and estimates of the frequency selectivity over the tile.

The estimates of the changes in channel phase over time and frequency for the tile can be fed to, e.g., digital phase-locked loops (DPLLs) for integration over many tiles and to estimate overall time and frequency offsets for the communications link, i.e. the specific mobile to base station link. These overall time and frequency offsets can then be compensated in a feedback manner by, e.g. numerically-controlled oscillators (NCOs) which provide opposite shifts to those offsets estimated.

The frequency variability is used to determine which pilot format is appropriate to the link. For channels with significant frequency variability, indicating a large channel delay spread, a pilot format with more frequency samples is desired.

In one example, processing is done on a sub-tile basis, where each sub-tile is a region in frequency and time bounded by four known pilots, or clusters of known pilots, at the corners; that is, at the highest and lowest points of time and frequency. Based upon these known pilots or clusters of pilots, an estimate of the channel conditions at the highest and lowest time and frequency can be obtained: from these estimates, an estimate of the channel conditions throughout the sub-tile can be derived by various known means: e.g., minimum mean square error (MMSE) or linear interpolation.

In order to make an estimate of the frequency offset in the receiver, the phase change from the lowest time to the highest time can be used. Similarly, in order to make an estimate of the time offset in the receiver, the phase change from the lowest frequency to the highest frequency can be used.

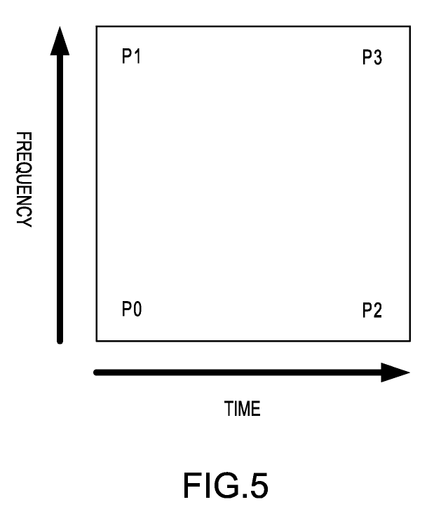

FIG. 5 illustrates an example of pilot or pilot cluster positions in the time-frequency plane showing four pilots, P0, P1, P2 and P3. The two channel estimates at the later time, P2 and P3 are averaged to determine an average estimate P23. Similarly, the two channel estimates at the earlier time, P0 and P1, are averaged to determine an average estimate P01.

In making a channel estimate, for example, a linear interpolation of some kind might be made between P01 and P23 to determine the values at intermediate points. In one aspect, the phase difference is taken. For example, a simple phase difference estimate may be obtained by taking diffest=imag (P23×P01*), where P01* is the conjugate of the complex channel estimate at the earlier time. This is equal to diffest=|P23|×|P01|×sin(angle (P23)−angle (P01)), which for small angles is approximately diffEst=|P23|×|P01|×(angle(P23)−angle (P01)). This diffEst may then be used, e.g., in a digital phase-locked loop (DPLL) to gradually correct the frequency error, so that the average of diffest will gradually tend towards zero. Similarly, phase differences between the higher and lower frequency channel estimates may be used to drive a DPLL to correct a time offset.

In another aspect, estimates are taken over several sub-tiles, so that several points in frequency are obtained. A metric of the variation over frequency can be taken, for example, the highest magnitude divided by the lowest magnitude over all frequencies. Although, in a fading channel, the amplitude may randomly be similar at multiple frequencies, if there is multipath present, at some point there will be a large difference between adjacent frequency channel estimate magnitudes—if the delay spread is large enough to cause the difference over that frequency difference.

If large enough channel estimate differences occur at adjacent pilot frequencies with sufficient regularity, an outer loop processor may deem that more frequency samples should be used in order to get a reliable channel estimate. This information can be used to switch between different pilot formats containing different pilot frequency spacings, if available. An outer loop processor can also be used for interference estimation, as follows: the tile processor can extract interference estimates in each tile, from which the outer loop processor can estimate the average interference level and possibly, the interference statistics. If the physical locations of the tile (i.e., their frequency ranges) are known to the outer loop processor, the outer loop processor can also measure interference and signal statistics on a sub-band basis.

Parameters extracted from each isolated region in time and frequency are passed from a channel estimator to an outer loop processor, which aggregates these extracted parameters to estimate the final parameters of interest (e.g., time and frequency offset and variability).

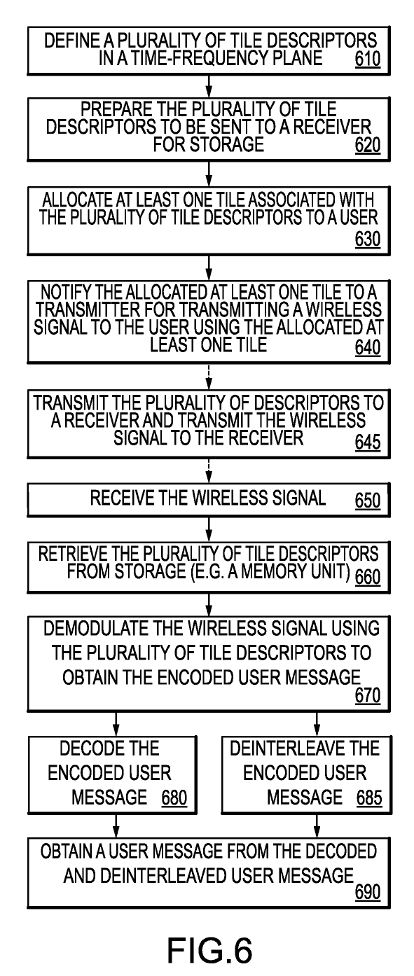

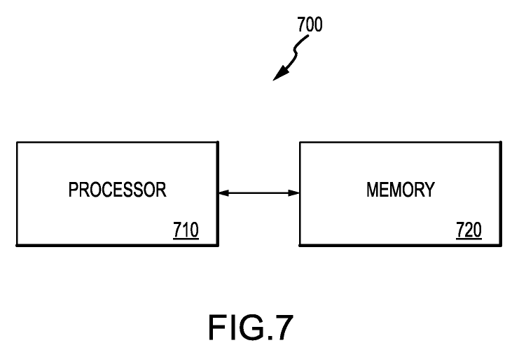

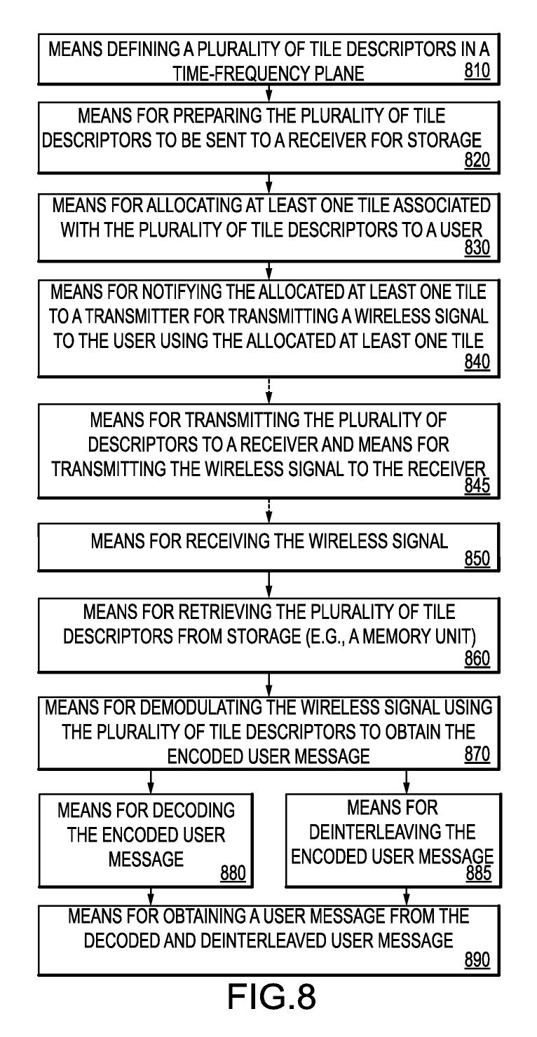

FIG. 6 illustrates an example flow for tile processing using pre-defined tile descriptors. In block 610, define a plurality of tile descriptors in a time-frequency plane. In one aspect, the plurality of tile descriptors comprises one or more of the following: shape of the tile (e.g., N subcarriers by M OFDM symbols); pilot or pilot cluster positions; pilot descrambling values; pilot cluster despreading functions; modulation order; or number of orthogonal layers (e.g., for MIMO or multi-access processing).

Following block 610, in block 620, prepare the plurality of tile descriptors to be sent to a receiver for storage. In one aspect, the receiver is coupled to a memory unit wherein the plurality of tile descriptors is stored upon receipt by the receiver. The memory unit may be a component of the receiver or an external unit to the receiver. Following block 620, in block 630, allocate at least one tile associated with the plurality of tile descriptors to a user. Following block 630, in block 640, notify the allocated at least one tile to a transmitter for transmitting a wireless signal to the user using the allocated at least one tile. In one aspect, the wireless signal comprises an encoded user message. In one example, a central entity performs the steps in blocks 610 through 640, the transmitter is a base station, and the receiver is a mobile station. Additionally, one skilled in the art would understand that the transmitter is not limited to a transmitting function only and may include a receiving function to allow for two-way communication. Similarly, the receiver is not limited to a receiving function only and may include a transmitting function to allow for two-way communication.

In block 645, the transmitter transmits the plurality of descriptors to a receiver and transmits the wireless signal to the receiver. One skilled in the art would understand that the plurality of descriptors and the wireless signals may be sent in parallel or in series, and that the order of transmission is not critical.

In block 650, the receiver receives the wireless signal. Following block 650, in block 660, retrieve the plurality of tile descriptors from storage (e.g., a memory unit). Following block 660, in block 670, demodulate the wireless signal using the plurality of tile descriptors to obtain the encoded user message. In one aspect, the demodulating step comprises one or more of the following: pilot extraction, channel estimation, maximal ratio combining (MRC) estimation, MIMO (multiple-input multiple-output) estimation, bit slicing or soft values/LLR (log-likelihood ratio) generation.

Following block 670, in block 680, decode the encoded user message. Following block 670, in block 685, deinterleave the encoded user message. One skilled in the art would understand that although blocks 680 and 685 are shown as parallel steps, that the order of the decoding and deinterleaving steps can be set by application, system parameters, operational considerations and/or user choice without affecting the spirit and scope of the present disclosure. Thus, in one example, the decoding step precedes the deinterleaving step, while in another example, the deinterleaving step precedes the decoding step without affecting the spirit and scope of the present disclosure. Following blocks 680 and 685, in block 690, obtain a user message from the decoded and deinterleaved user message.

In one aspect, a receiver performs the steps in blocks 650 through block 690. In one example, the receiver comprises an antenna for receiving the wireless signal and the plurality of tile descriptors. Also, the receiver further comprises a memory unit for storing the plurality of tile descriptors, and a processor for retrieving the plurality of tile descriptors from the memory unit and for demodulating the wireless signal using the plurality of tile descriptors to obtain the encoded user message.

One skilled in the art would understand that the steps disclosed in the example flow diagram in FIG. 6 can be interchanged in their order without departing from the scope and spirit of the present disclosure. Also, one skilled in the art would understand that the steps illustrated in the flow diagram are not exclusive and other steps may be included or one or more of the steps in the example flow diagram may be deleted without affecting the scope and spirit of the present disclosure.

Those of skill would further appreciate that the various illustrative components, logical blocks, modules, circuits, and/or algorithm steps described in connection with the examples disclosed herein may be implemented as electronic hardware, firmware, computer software, or combinations thereof To clearly illustrate this interchangeability of hardware, firmware and software, various illustrative components, blocks, modules, circuits, and/or algorithm steps have been described above generally in terms of their functionality. Whether such functionality is implemented as hardware, firmware or software depends upon the particular application and design constraints imposed on the overall system. Skilled artisans may implement the described functionality in varying ways for each particular application, but such implementation decisions should not be interpreted as causing a departure from the scope or spirit of the present disclosure.

For example, for a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described therein, or a combination thereof With software, the implementation may be through modules (e.g., procedures, functions, etc.) that perform the functions described therein. The software codes may be stored in memory units and executed by a processor unit. Additionally, the various illustrative flow diagrams, logical blocks, modules and/or algorithm steps described herein may also be coded as computer-readable instructions carried on any computer-readable medium known in the art or implemented in any computer program product known in the art.

In one or more examples, the steps or functions described herein may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

In one example, the illustrative components, flow diagrams, logical blocks, modules and/or algorithm steps described herein are implemented or performed with one or more processors. In one aspect, a processor is coupled with a memory which stores data, metadata, program instructions, etc. to be executed by the processor for implementing or performing the various flow diagrams, logical blocks and/or modules described herein. FIG. 7 illustrates an example of a device 700 comprising a processor 710 in communication with a memory 720 for executing the processes for tile processing using pre-defined tile descriptors. In one example, the device 700 is used to implement the algorithm illustrated in FIG. 6. In one aspect, the memory 720 is located within the processor 710. In another aspect, the memory 720 is external to the processor 710. In one aspect, the processor includes circuitry for implementing or performing the various flow diagrams, logical blocks and/or modules described herein.

FIG. 8 illustrates an example of a device 800 suitable for tile processing using pre-defined tile descriptors. In one aspect, the device 800 is implemented by at least one processor comprising one or more modules configured for tile processing using pre-defined tile descriptors as described herein in blocks 810, 820, 830, 840, 845, 850, 860, 870, 880, 885 and 890. For example, each module comprises hardware, firmware, software, or any combination thereof. In one aspect, the device 800 is also implemented by at least one memory in communication with the at least one processor.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure.

1. A method for tile processing using a plurality of tile descriptors comprising:
defining the plurality of tile descriptors in a time-frequency plane;
preparing the plurality of tile descriptors to be sent to a receiver for storage;
allocating at least one tile associated with the plurality of tile descriptors to a user; and
notifying the allocated at least one tile to a transmitter for transmitting a wireless signal to the user using the allocated at least one tile.

2. The method of claim 1 wherein the plurality of tile descriptors comprises one or more of the following: shape of the tile, pilot or pilot cluster positions, pilot descrambling values, pilot cluster despreading functions, modulation order or number of orthogonal layers.

3. The method of claim 1 wherein the wireless signal comprises an encoded user message.

4. The method of claim 3 wherein the steps of claim 1 are performed by a central entity in communication with the transmitter.

5. The method of claim 4 wherein the transmitter is a base station and the receiver is a mobile station.

6. The method of claim 1 further comprising transmitting the plurality of descriptors and the wireless signal to the receiver.

7. A method for tile processing using a plurality of tile descriptors comprising:
receiving a wireless signal, wherein the wireless signal comprises an encoded user message;
retrieving the plurality of tile descriptors from a memory unit; and
demodulating the wireless signal using the plurality of tile descriptors to obtain the encoded user message.

8. The method of claim 7 further comprising decoding the encoded user message.

9. The method of claim 7 further comprising deinterleaving the encoded user message.

10. The method of claim 7 further comprising decoding and deinterleaving the encoded user message to obtain a user message.

11. The method of claim 7 further comprising storing the plurality of tile descriptions in the memory unit.

12. The method of claim 11 wherein the memory unit is a component of a receiver.

13. The method of claim 7 wherein the plurality of tile descriptors comprises one or more of the following: shape of the tile, pilot or pilot cluster positions, pilot descrambling values, pilot cluster despreading functions, modulation order or number of orthogonal layers.

14. The method of claim 13 wherein the demodulating step comprises one or more of the following: pilot extraction, channel estimation, maximal ratio combining (MRC) estimation, MIMO (multiple-input multiple-output) estimation, bit slicing or soft values/LLR (log-likelihood ratio) generation.

15. The method of claim 14 further comprising decoding and deinterleaving the encoded user message to obtain a user message.

16. A central entity for tile processing using a plurality of tile descriptors comprising:
an input/output interface for receiving and transmitting a wireless signal; and
a processor coupled with a memory storing software codes, wherein the software codes are instructions implemented by the processor to:
a) define the plurality of tile descriptors in a time-frequency plane;
b) prepare the plurality of tile descriptors to be sent to a receiver for storage;
c) allocate at least one tile associated with the plurality of tile descriptors to a user; and
d) notify the allocated at least one tile to a transmitter for transmitting the wireless signal to the user using the allocated at least one tile.

17. The central entity of claim 16 wherein the plurality of tile descriptors comprises one or more of the following: shape of the tile, pilot or pilot cluster positions, pilot descrambling values, pilot cluster despreading functions, modulation order or number of orthogonal layers.

18. The central entity of claim 16 wherein the wireless signal comprises an encoded user message.

19. The central entity of claim 18 wherein the transmitter is a base station and the receiver is a mobile station.

20. A receiver for tile processing using a plurality of tile descriptors comprising:
an antenna for receiving a wireless signal wherein the wireless signal comprises an encoded user message, and for receiving the plurality of tile descriptors;
a memory unit for storing the plurality of tile descriptors; and
a processor for retrieving the plurality of tile descriptors from the memory unit and for demodulating the wireless signal using the plurality of tile descriptors to obtain the encoded user message.

21. The receiver of claim 20 wherein the processor is further configured to decode the encoded user message.

22. The receiver of claim 20 wherein the processor is further configured to deinterleave the encoded user message.

23. The receiver of claim 20 wherein the processor is further configured to decode and deinterleave the encoded user message to obtain a user message.

24. The receiver of claim 20 wherein the plurality of tile descriptors comprises one or more of the following: shape of the tile, pilot or pilot cluster positions, pilot descrambling values, pilot cluster despreading functions, modulation order or number of orthogonal layers.

25. The receiver of claim 24 wherein the processor demodulates the wireless signal by performing one or more of the following: pilot extraction, channel estimation, maximal ratio combining (MRC) estimation, MIMO (multiple-input multiple-output) estimation, bit slicing or soft values/LLR (log-likelihood ratio) generation.

26. The receiver of claim 25 wherein the processor is further configured to decode and deinterleave the encoded user message to obtain a user message.

27. An apparatus for tile processing using a plurality of tile descriptors comprising:
means for defining the plurality of tile descriptors in a time-frequency plane;
means for preparing the plurality of tile descriptors to be sent to a receiver for storage;
means for allocating at least one tile associated with the plurality of tile descriptors to a user; and
means for notifying the allocated at least one tile to a transmitter for transmitting a wireless signal to the user using the allocated at least one tile.

28. The apparatus of claim 27 wherein the plurality of tile descriptors comprises one or more of the following: shape of the tile, pilot or pilot cluster positions, pilot descrambling values, pilot cluster despreading functions, modulation order or number of orthogonal layers.

29. The apparatus of claim 27 wherein the wireless signal comprises an encoded user message.

30. The apparatus of claim 29 wherein the transmitter and the receiver are external to the apparatus.

31. The apparatus of claim 27 further comprising means for transmitting the plurality of descriptors and the wireless signal to the receiver.

32. An apparatus for tile processing using a plurality of tile descriptors comprising:
means for receiving a wireless signal, wherein the wireless signal comprises an encoded user message;
means for retrieving the plurality of tile descriptors from a memory unit; and
means for demodulating the wireless signal using the plurality of tile descriptors to obtain the encoded user message.

33. The apparatus of claim 32 further comprising means for decoding and deinterleaving the encoded user message to obtain a user message.

34. The apparatus of claim 32 further comprising means for storing the plurality of tile descriptions in the memory unit.

35. The apparatus of claim 32 wherein the plurality of tile descriptors comprises one or more of the following: shape of the tile, pilot or pilot cluster positions, pilot descrambling values, pilot cluster despreading functions, modulation order or number of orthogonal layers.

36. The apparatus of claim 35 wherein the means for demodulating comprises one or more of the following: means for pilot extraction, means for channel estimation, means for maximal ratio combining (MRC) estimation, means for MIMO (multiple-input multiple-output) estimation, means for bit slicing or means for soft values/LLR (log-likelihood ratio) generation.

37. A computer-readable medium having a computer program comprising instructions, which when executed by at least one processor, operates to process tiles using a plurality of tile descriptors, the computer program comprising:
instructions for defining the plurality of tile descriptors in a time-frequency plane;
instructions for preparing the plurality of tile descriptors to be sent to a receiver for storage;
instructions for allocating at least one tile associated with the plurality of tile descriptors to a user; and
instructions for notifying the allocated at least one tile to a transmitter for transmitting a wireless signal to the user using the allocated at least one tile.

38. A computer-readable medium having a computer program comprising instructions, which when executed by at least one processor, operates to process tiles using a plurality of tile descriptors, the computer program comprising:
instructions for receiving a wireless signal, wherein the wireless signal comprises an encoded user message;
instructions for retrieving the plurality of tile descriptors from a memory unit; and
instructions for demodulating the wireless signal using the plurality of tile descriptors to obtain the encoded user message.

39. The computer-readable medium of claim 38 further comprising instructions for decoding and deinterleaving the encoded user message to obtain a user message.

40. The computer-readable medium of claim 38 wherein the plurality of tile descriptors comprises one or more of the following: shape of the tile, pilot or pilot cluster positions, pilot descrambling values, pilot cluster despreading functions, modulation order or number of orthogonal layers.

41. The computer-readable medium of claim 40 wherein the instructions for demodulating comprise one or more of the following: instructions for pilot extraction, instructions for channel estimation, instructions for maximal ratio combining (MRC) estimation, instructions for MIMO (multiple-input multiple-output) estimation, instructions for bit slicing or instructions for soft values/LLR (log-likelihood ratio) generation.

42. The method of claim 4 wherein the transmitter is a mobile station and the receiver is a base station.

43. The central entity of claim 18 wherein the transmitter is a mobile station and the receiver is a base station.
